(19) United States
(12) Patent Application Publication
(10) Pub. No.: US 2012/0293752 A1
(43) Pub. Date: Nov. 22, 2012

(54) LIQUID CRYSTAL DISPLAY DEVICE

(75) Inventors: Arihiro TAKEDA, Saitama-ken (JP); Jin HIROSAWA, Saitama-ken (JP); Hitomi HASEGAWA, Saitama-ken (JP); Yusuke MORITA, Saitama-ken (JP); Hirokazu MORIMOTO, Saitama-ken (JP)

(73) Assignee: Japan Display Central Inc., Fukaya-shi (JP)

(21) Appl. No.: 13/470,578

(22) Filed: May 14, 2012

(30) Foreign Application Priority Data
May 19, 2011 (JP) 2011-112475

(51) Int. Cl. G02F 1/1343; G02F 1/1335; G02F 1/1337

(52) U.S. Cl. 349/96; 349/143; 349/132

(57) ABSTRACT

A liquid crystal display device includes a first substrate having a pair of first signal lines and a pair of second signal lines extending in a first and orthogonal second directions, and a pixel electrode arranged between the pair of second signal lines and extending in the second direction, and a second substrate having a first main common electrode and a second main common electrode respectively facing the pair of second signal lines and extending in the second direction. An effective domain is surrounded by the pairs of first and second signal lines, or by the pair of the first signal lines and the first and the second main common electrodes. A first area formed of an electrode portion including the pixel electrode is smaller than a second area formed of an aperture portion other than the first area in the effective domain.

### CROSS-REFERENCE TO RELATED APPLICATION

This application is based upon and claims the benefit of priority from Japanese Patent Application No. P2011-112475, filed May 19, 2011, the entire contents of which are incorporated herein by reference.

### FIELD

Embodiments described herein relate generally to a liquid crystal display device.

### BACKGROUND

In recent years, a flat panel display is developed briskly, and especially, the liquid crystal display device gets a lot of attention from advantages, such as light weight, thin shape, and low power consumption. Especially, in an active matrix type liquid crystal display device equipped with a switching element in each pixel, a structure using lateral electric field, such as IPS (In-Plane Switching) mode and FFS (Fringe Field Switching) mode, attracts attention. The liquid crystal display device using the lateral electric field mode is equipped with pixel electrodes and a common electrode formed in an array substrate, respectively. Liquid crystal molecules are switched by the lateral electric field substantially in parallel with the principal surface of the array substrate.

On the other hand, another technique is also proposed, in which the liquid crystal molecules are switched using the lateral electric field or an oblique electric field between the pixel electrode formed in the array substrate and the common electrode formed in a counter substrate.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a figure schematically showing a structure of a liquid crystal display device according to an embodiment.

FIG. 2 is a figure schematically showing the structure and an equivalent circuit of a liquid crystal display panel shown in FIG. 1.

FIG. 3 is a plan view schematically showing the structure of one pixel when the liquid crystal display panel according to one embodiment is seen from a counter substrate side.

FIG. 4 is a view schematically showing a cross-sectional structure of the liquid crystal display panel taken along line A-A in FIG. 3.

FIG. 5 is a plan view schematically showing an effective domain formed in one pixel.

FIG. 6 is a figure showing electric field distribution in the FFS mode in one pixel in the liquid crystal display panel.

FIG. 7 is a figure showing the relation between a director of a liquid crystal molecule and transmissivity by electric field between a comb-like electrode and a common electrode in the FFS mode in the liquid crystal display panel shown in FIG. 6.

FIG. 8 is a figure showing the relation between the director of the liquid crystal molecule and transmissivity by electric field between a pixel electrode and a common electrode in the liquid crystal display panel according to a first embodiment.

FIG. 9 is a figure showing the relation between the director of the liquid crystal molecule and transmissivity by electric field between the pixel electrode and the common electrode when an assembling shift arises between an array substrate and a counter substrate in the liquid crystal display panel according to the first embodiment.

FIG. 10 is a figure showing a result of a simulation about the relation between resolution and transmissivity in a display mode according to the first embodiment and the FFS mode.

FIG. 11 is a plan view schematically showing the structure of one pixel when the liquid crystal display panel according to a second embodiment is seen from the counter substrate side.

FIG. 12 is a plan view schematically showing an effective domain formed in one pixel.

FIG. 13 is a plan view schematically showing the structure of one pixel when the liquid crystal display panel according to a third embodiment is seen from the counter substrate side.

FIG. 14 is a plan view schematically showing the structure of one pixel when the liquid crystal display panel according to a fourth embodiment is seen from the counter substrate side.

### DETAILED DESCRIPTION OF THE INVENTION

A liquid crystal display device according to an exemplary embodiment of the present invention will now be described with reference to the accompanying drawings wherein the same or like reference numerals designate the same or corresponding portions throughout the several views.

According to this embodiment, a liquid crystal display device includes: a first substrate including; a pair of first signal lines extending in a first direction and a pair of second signal lines extending in a second direction orthogonally crossing the first direction, and a pixel electrode arranged between the pair of second signal lines and extending in the second direction, a second substrate including a common electrode having a first main common electrode and a second main common electrode respectively facing the pair of the second signal lines and extending in the second direction, and a liquid crystal layer having liquid crystal molecules and held between the first substrate and the second substrate; wherein the liquid crystal display device further includes an effective domain surrounded by the pair of first signal lines and the pair of second signal lines, or by the pair of first signal lines and the first and the second main common electrodes, and a first area formed of an electrode portion including the pixel electrode is smaller than a second area formed of an aperture portion other than the first area in the effective domain.

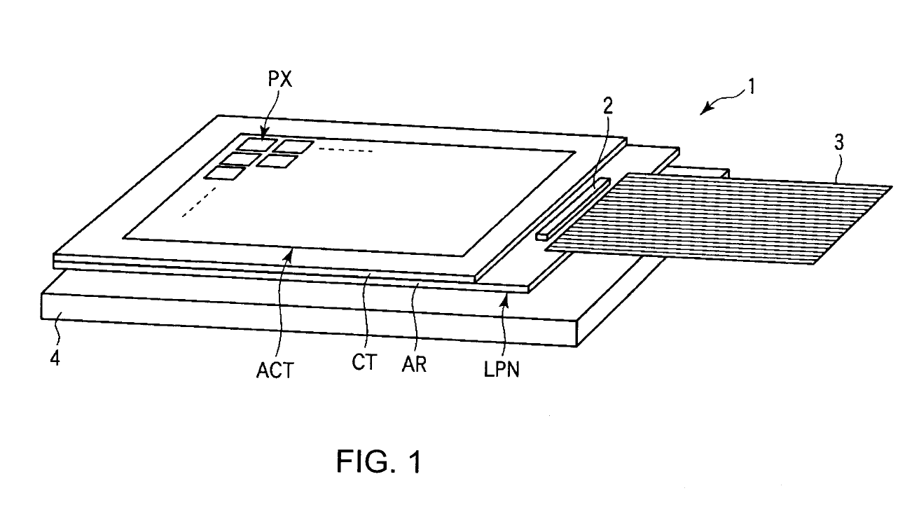

FIG. 1 is a figure schematically showing a structure of the liquid crystal display device 1 according to one embodiment.

The liquid crystal display device 1 includes an active-matrix type liquid crystal display panel LPN, a driver IC chip 2 connected to the liquid crystal display panel LPN, a flexible wiring substrate 3, a backlight 4 for illuminating the liquid crystal display panel LPN, etc.

The liquid crystal display panel LPN is equipped with an array substrate AR as a first substrate, a counter substrates CT as a second substrate arranged opposing the array substrate AR, a liquid crystal layer (not shown) held between the array substrate AR and the counter substrate CT, a first optical element provided on the backlight 4 side to control the polarizing state of incident light to the liquid crystal display panel LPN, and a second optical element provided on the surface side of the panel LPN to control the polarizing state of emitting light. The liquid crystal display panel LPN includes an active area ACT which displays images. The active area ACT is constituted by a plurality of pixels PX arranged in the shape of a (m×n) matrix (here, “m” and “n” are positive integers).

The backlight 4 is arranged on the back side of the array substrate AR in the illustrated example. Various types of backlights 4 can be used. For example, a light emitting diode (LED) or a cold cathode fluorescent lamp (CCFL), etc., can be applied as a light source of the backlight 4, and the explanation about its detailed structure is omitted.

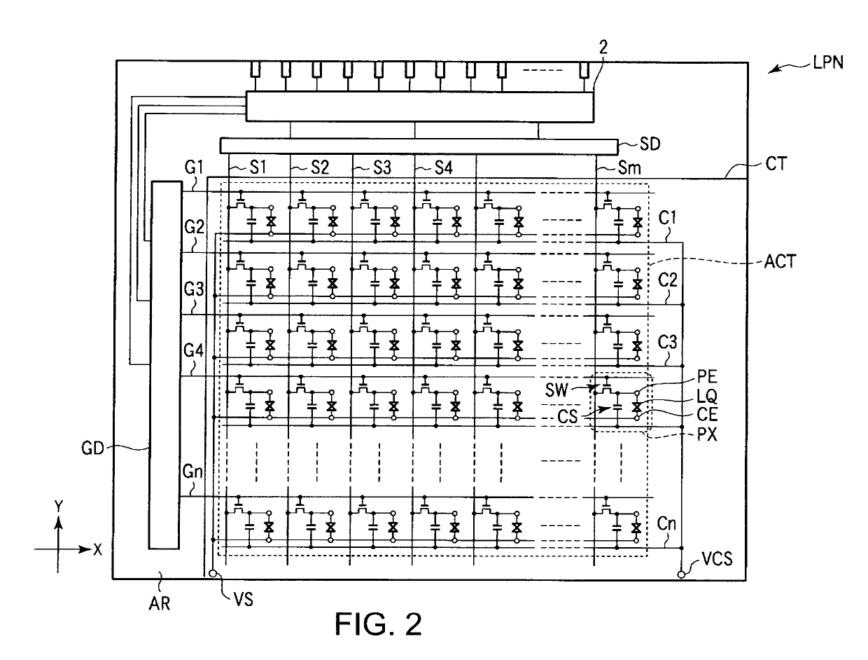

FIG. 2 is a figure schematically showing the structure and an equivalent circuit of the liquid crystal display panel LPN shown in FIG. 1.

The liquid crystal display panel LPN is equipped with “n” gate lines G (G1-Gn), “n” auxiliary capacitance lines C (C1-Cn), “m” source lines S (S1-Sm), etc., in the active area ACT. The gate line G and the auxiliary capacitance line C correspond to first signal lines extending in a first direction, respectively. The gate line G and the auxiliary capacitance line C do not necessarily extend linearly. The gate line G and the auxiliary capacitance line C are arranged along a second direction Y that orthogonally intersects the first direction X. The source lines S cross the gate line G and the capacitance line C. The source lines S correspond to second signal lines extending, respectively, in the second direction Y. Though the source lines S extend in the second direction Y, respectively, they do not necessarily extend linearly. The gate line G, the auxiliary capacitance line C and the source lines S may be crooked partially.

Each gate line G is pulled out to the outside of the active area ACT, and is connected to a gate driver GD. Each source line S is pulled out to the outside of the active area ACT, and is connected to a source driver SD. At least a portion of the gate driver GD and the source driver SD is formed in the array substrate AR, for example, and the gate driver GD and the source driver SD are connected with the driver IC chip 2 provided in the array substrate AR and having an implemented controller.

Each pixel PX includes a switching element SW, a pixel electrode PE, a common electrode CE, etc. Retention capacitance Cs is formed, for example, between the auxiliary capacitance line C and the pixel electrode PE. The auxiliary capacitance line C is electrically connected with a voltage impressing portion VCS to which the auxiliary capacitance voltage is impressed.

In addition, in the liquid crystal display panel LPN according to this embodiment, while the pixel electrode PE is formed in the array substrate AR, the common electrode CE is formed in the counter substrate CT. Liquid crystal molecules of a liquid crystal layer LQ are switched mainly using an electric field formed between the pixel electrodes PE and the common electrodes CE. The electric field formed between the pixel electrode PE and the common electrode CE is a lateral electric field substantially in parallel with the principal surface of the array substrate AR or the principal surface of the counter substrate CT, or an oblique electric field slightly oblique with respect to the principle surfaces of the substrates.

The switching element SW is constituted by n channel type thin film transistor (TFT), for example. The switching element SW is electrically connected with the gate line G and the source line S. The (m×n) switching elements SW are formed in the active area ACT. The switching element SW may be either a top-gate type or a bottom-gate type. Though the semiconductor layer is formed of poly-silicon, the semiconductor layer may be formed of amorphous silicon.

The pixel electrode PE is electrically connected with the switching element SW. The (m×n) pixel electrodes PE are formed in the active area ACT. The common electrode CE is set to a common potential, for example. The common electrode CE is arranged in common to the plurality of pixel electrodes PE through the liquid crystal layer LQ. Though the pixel electrode PE and the common electrode CE are formed by light transmissive conductive materials, such as Indium Tin Oxide (ITO), Indium Zinc Oxide (IZO), etc., other metals such as aluminum may be used.

The array substrate AR includes an electric power supply portion VS formed outside of the active area ACT. Furthermore, the common electrode CE formed on the counter substrate CT is electrically connected with the electric power supply portion VS formed in the array substrate AR through an electric conductive component which is not illustrated.

### First Embodiment

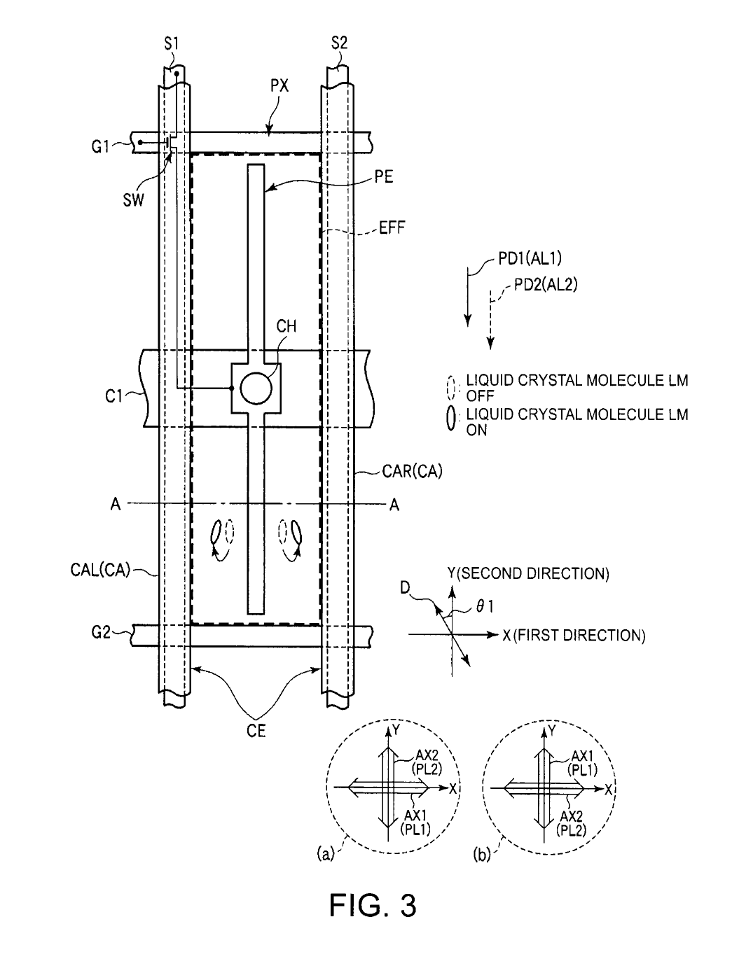

FIG. 3 is a plan view schematically showing the structure of one pixel when the liquid crystal display panel according to one embodiment is seen from the counter substrate side. Herein, a plan view in a X-Y plane specified in the first direction X and the second direction Y is shown.

The array substrate includes a gate line G1 and a gate line G2 which extend in the first direction X, a capacitance line C1 arranged between the adjoining the gate line G1 and the gate line G2 and extending along the first direction X, a source line S1 and a source line S2 and a pixel electrode PE which extend along the second direction Y.

In the illustrated example, the source line S1 is arranged at the left-hand side end in the pixel PX. Precisely, the source line S1 is arranged striding over a boundary between the illustrated pixel and a pixel PX adjoining the illustrated pixel PX on the left-hand side. The source line S2 is arranged at the right-hand side end. Precisely, the source line S2 is arranged striding over a boundary between the illustrated pixel and a pixel PX adjoining the illustrated pixel PX on the right-hand side. Moreover, in the pixel PX, the gate line G1 is arranged at an upper end portion. Precisely, the gate line G1 is arranged striding over a boundary between the illustrated pixel and a pixel which adjoins the illustrated pixel PX on its upper end side. The gate line G2 is arranged at a lower end portion. Precisely, the gate line G2 is arranged striding over a boundary between the illustrated pixel and a pixel which adjoins the illustrated pixel PX on its lower end side. The auxiliary capacitance line C1 is arranged approximately in a central portion of the pixel PX.

The switching element SW is electrically connected with the gate line G1 and the source line S1 in the illustrated example. Namely, the switching element SW is formed in an intersection of the gate line G1 with the source line S1. A drain line extends along the source line S1 and the auxiliary capacitance line C1, and is electrically connected with the pixel electrode PE through a contact hole CH formed in a region which overlaps with the auxiliary capacitance line C1. The switching element SW hardly runs off the overlapped region with the source line S1 and the auxiliary capacitance line C1. Thereby, reduction of the area of an aperture which contributes to a display is suppressed when the switching element SW is arranged in the pixel PX.

In the illustrated pixel PX, the region shown with a dashed line in the figure corresponds to the effective domain EFF. The effective domain EFF is a region surrounded with the gate line G1 and the gate line G2, the source line S1 and the source line S2, or the main common electrode CA to be mentioned later. That is, the effective domain EFF is defined by inside edges of the respective signal lines or inside edges of the main common electrode CA. The effective domain EFF has the shape of a rectangle whose length in the second direction Y is larger than the length in the first direction X. That is, each edge of the gate line G1 and the gate line G2 which face each other corresponds to the short end of the effective domain EFF. Moreover, in the illustrated example, each edge of the main common electrode CA which faces each other corresponds the long end of the effective domain EFF.

The pixel electrode PE is arranged between the adjoining source line S1 and the source line S2. Moreover, the pixel electrode PE is arranged between the gate line G1 and the gate line G2. That is, the pixel electrode PE is arranged in the effective domain EFF. The pixel electrode PE extends along the second direction Y. That is, the pixel electrode PE is formed in the shape of a belt linearly extending along the second direction Y. In the illustrated example, in the region which overlaps with the auxiliary capacitance line C1, the pixel electrode PE is formed more widely than other portions so as to secure contact with the switching element SW through the contact hole CH. That is, the pixel electrode PE is formed so as to have the same width along the first direction X in the region which does not overlap with the auxiliary capacitance line C1.

The pixel electrode PE is located inside the effective domain EFF rather than the position on the adjoining source line S1 and the source line S2. More specifically, the pixel electrode PE is arranged in the position of approximately center between the source line S1 and the source line S2, i.e., the center of the pixel PX. The distance between the source line S1 and the pixel electrode PE in the first direction X is substantially equal to that between the source line S2 and the pixel electrode PE in the first direction X. The pixel electrode PE extends from a vicinity of an upper end to a vicinity of a bottom end of the pixel PX.

The counter substrate is equipped with a common electrode CE. The common electrode CE includes a main common electrode CA which extends along the second direction Y while countering with each of the source lines S. That is, the main common electrode CA is formed in a belt shape or in a stripe shape extending linearly along the second direction Y. Although not explained in detail, the main common electrode CA is pulled out to the outside of the active area, and is electrically connected with the electric supply portion formed in the array substrate through an electric conductive component, and common potential is supplied.

In the illustrated example, the main common electrode CA is arranged in two lines in parallel along the first direction X. Hereinafter, in order to distinguish the two lines, the main common electrode CA of the left-hand side in the figure is called CAL, and the main common electrode of the right-hand side in a figure is called CAR. The main common electrode CAL counters with the source line S1, and the main common electrode CAR counters with the source line S2. That is, the main common electrode CA is arranged on the both ends of the pixel, respectively.

In the pixel PX, the main common electrode CAL is arranged at the left-hand side end. Precisely, the main common electrode CAL is arranged striding over a boundary between the illustrated pixel and a pixel which adjoins the illustrated pixel PX on the left-hand side. The main common electrode CAR is arranged at the right-hand side end. Precisely, the main common electrode CAL is arranged striding over a boundary between the illustrated pixel and a pixel which adjoins the illustrated pixel PX on the right-hand side.

Moreover, the main common electrode CA has a width equal to or larger than the source line S which counters. In the illustrated example, the width of the main common electrode CAL in the first direction X is larger than the width of the source line S1 which counters the main common electrode CAL in the first direction X, and has the width equal to or smaller than the black matrix BM to be mentioned later. Moreover, the main common electrode CAL is arranged right above the source line S1, and is arranged right under the black matrix BM. Accordingly, the main common electrode CAL is arranged right above the source line of S1 and does not extend to the effective domain EFF side beyond the position right under the black matrix BM. That is, the main common electrode CAL does not extend to the pixel electrode PE side beyond the position right under the black matrix BM. Similarly, the width of the main common electrode CAR in the first direction X is larger than the width of the source line S2, which counters the main common electrode CAR in the first direction X, and has the width equal to or smaller than the black matrix BM to be mentioned later. Moreover, the main common electrode CAR is arranged right above the source line S2, and is arranged right under the black matrix BM. Accordingly, the main common electrode CAR is arranged on the soured line S2 and does not extend to the effective domain EFF side beyond the position right under the black matrix BM. That is, the main common electrode CAR does not extend to the pixel electrode PE side beyond the position right under the black matrix BM. Thus, when the main common electrode CA is arranged in the pixel PX, reduction of the area of the aperture which contributes to a display is suppressed.

Thus, in case the main common electrode CA has the width larger than the that of the source line S which counters the main common electrode CA, the main common electrode CA runs off the source line S extending to the pixel electrode PE side. Accordingly, the respective inside edges of the main common electrode CA, which face each other, correspond to the long ends of the effective domain EFF. However, in order to control reduction of the area of the aperture which contributes to the display as much as possible, it is desirable to set up the extended area of the main common electrode CA to the pixel electrode side as small as possible.

In addition, the main common electrode CA may have the width smaller than the width of the source line S which counters the main common electrode CA. In this case, the source line S runs off the position right under the main common electrode CA extending to the pixel electrode PE side, and the respective edges of the source lines S facing each other correspond to the long ends of the effective domain EFF.

The main common electrode CA is arranged on the both sides which sandwich the pixel electrode PE. That is, the pixel electrode PE and the main common electrode CA are arranged by turns along the first direction X. The pixel electrodes PE and the main common electrode CA are substantially in parallel each other. At this time, any of the main common electrodes CA overlap with the pixel electrode PE in the X-Y plane.

One pixel electrode PE is located between the adjoining main common electrode CAL and the main common electrode CAR. The main common electrode CAL and the main common electrode CAR are arranged on the both sides which face across the position right above the pixel electrode PE. The pixel electrode PE is arranged between the main common electrode CAL and the main common electrode CAR. For this reason, the main common electrode CAL, the main pixel electrode PE, and the main common electrode CAR are arranged along the first direction X in this order. The inter-electrode distance between the main common electrode CAL and the pixel electrode PE in the first direction X is substantially the same as that between the main common electrode CAR and the pixel electrode PE in the first direction X.

The inter-electrode distance between the main common electrode CAL and the pixel electrode PE in the first direction X in the X-Y plane, and the inter-electrode distance between the main common electrode CAR and the pixel electrode PE in the first direction X are less than 15 μm for example. Under the above inter-electrode distance, it is desirable to use the liquid crystal molecule whose value of dielectric anisotropy E is equal to ten or more, as the liquid crystal layer LQ.

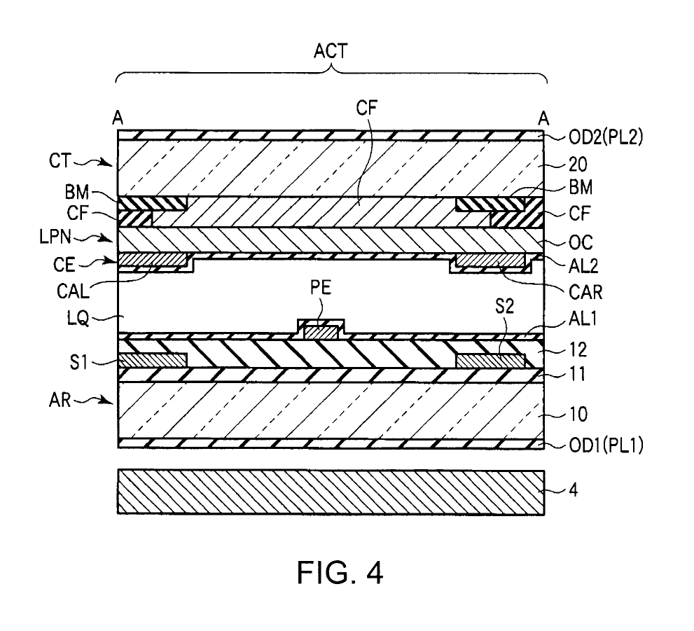

FIG. 4 is a view schematically showing a cross-sectional structure of the liquid crystal display panel taken along line A-A in FIG. 3. In addition, only the portion required for explanation is illustrated here.

A backlight 4 is arranged on the back side of the array substrate AR which constitutes the liquid crystal display panel LPN.

The array substrate AR is formed using a first insulating substrate 10 which has a transmissive characteristics. The source line S1 and the source line S2 are formed on a first interlayer insulating film 11, and are covered with a second interlayer insulation film 12. In addition, the gate line and the auxiliary capacitance line which are not illustrated are arranged between the first insulating substrate 10 and the first interlayer insulating film 11, for example. The pixel electrode PE is formed on the second interlayer insulating film 12.

A first alignment film AL1 is arranged on the array substrate AR facing the counter substrate CT, and extends to whole active region. The first alignment film AL1 covers the pixel electrode PE, etc., and is arranged also on the second interlayer insulation film 12. The first alignment film AL1 is formed of the material which shows a lateral alignment characteristics.

In addition, the array substrate AR may be further equipped with a portion of the common electrodes CE.

The counter substrate CT is formed using a second insulating substrate 20 which has a transmissive characteristics. The counter substrate CT includes the black matrix BM, a color filter CF, an overcoat layer OC, the common electrode CE, and the second alignment film AL2, etc., on the side which counters the array substrate AR of the second insulating substrate 20.

The black matrix BM is formed on the second insulating substrate 20, and defines each pixel PX. That is, the black matrix BM is arranged so that line portions, such as the source line, the gate line, the auxiliary capacitance line, and the switching element, may counter the black matrix BM. The color filter CF is formed on the second insulating substrate 20, and is arranged corresponding to each pixel PX. That is, while the color filter CF is arranged in the inner region divided by the black matrix BM, a portion thereof overlaps with the black matrix BM. The overcoat layer OC is formed on the black matrix BM and the color filter CF. That is, the overcoat layer OC is arranged so that the influence of the concave-convex of the surface of the black matrix BM and color filter CF may be suppressed.

The common electrode CE is formed on the overcoat layer OC. The main common electrode CA of the common electrode CE counters with the black matrix BM. The main common electrode CA has a width equal to or smaller than the black matrix BM which counters the main common electrode CA. The widths of the main common electrode CAL and the main common electrode CAR in the first direction X in the illustrated example are smaller than the width of the black matrix BM in the first direction X, respectively. The main common electrodes CAL and the main common electrode CAR are arranged right under the black matrix BM, respectively.

The second alignment film AL2 is arranged on the surface of the counter substrate CT opposing the surface of the array substrate AR, and extends to approximately whole of the active area ACT. The second alignment film AL2 covers the common electrodes CE, and is also arranged on the overcoat layer OC. The second alignment film AL2 is formed materials which have a lateral alignment characteristics

An alignment treatment (for example, rubbing treatment and photo alignment treatment) is performed for making the first and second alignment films AL1 and AL2 in an initial alignment state. The direction of the first alignment treatment in which the first alignment film AL1 carries out the initial alignment of the liquid crystal molecule, and the direction of the second alignment treatment in which the second alignment film AL2 carries out the initial alignment of the liquid crystal molecule, are respectively directions in parallel to the second direction Y. The first and second alignment directions are in parallel each other, and same directions or reverse directions each other.

The array substrate AR and the counter substrate CT as mentioned-above are arranged so that the first alignment film AL1 and the second alignment film AL2 face each other. In this case, the pillar-shaped spacer is formed integrally with one of the substrates by resin material between the first alignment film AL1 on the array substrate AR and the second alignment film AL2 on the counter substrate CT. Thereby, a predetermined gap, for example, a 2-7 μm cell gap, is formed, for example. The array substrate AR and the counter substrate CT are pasted together by seal material which is not illustrated, in which the predetermined cell gap is formed.

The liquid crystal layer LQ is held at the cell gap formed between the array substrate AR and the counter substrate CT, and is arranged between the first alignment film AL1 and the second alignment film AL2. The liquid crystal layer LQ contains the liquid crystal molecule which is not illustrated. The liquid crystal layer LQ is constituted by positive type liquid crystal material.

A first optical element OD1 is attached to the external surface of the array substrate AR, i.e., the external surface of the first insulating substrate 10 which constitutes the array substrate AR by adhesives, etc. The first optical element OD1 contains a first polarizing plate PL1 which has a first polarization axis AX1. Moreover, a second optical element OD2 is attached to the external surface of the counter substrate CT, i.e., the external surface of the second insulating substrate 20 which constitutes the counter substrate CT by adhesives, etc. The second optical element OD2 contains a second polarizing plate PL2 which has a second polarization axis AX2. The first polarization axis AX1 of the first polarizing plate PL1 and the second polarization axis AX2 of the second polarizing plate PL2 are in the relationship in which the first and second polarization axis AX1, AX2 intersect perpendicularly each other, for example. One polarizing plate is arranged, for example, so that its polarizing direction is the direction of the long axis of the liquid crystal molecule, i.e., a direction in parallel with the first alignment treatment direction or the second alignment treatment direction (or in parallel with the second direction Y), or in orthogonal direction (or in parallel with the first direction X). Thereby, the normally black mode is achieved.

Next, an operation of the liquid crystal display panel LPN of the above-mentioned structure is explained.

Namely, at the time of non-electric field state, i.e., when a potential difference (i.e., electric field) is not formed between the pixel electrode PE and the common electrode CE, the liquid crystal molecules LM of the liquid crystal layer LQ are aligned so that their long axis are aligned in a parallel direction with the first alignment direction PD1 of the first alignment film AL1 and the second alignment direction PD2 of the second alignment film AL2 as shown with a dashed line in the figure. In this state, the time of OFF corresponds to the initial alignment state, and the alignment direction of the liquid crystal molecule LM corresponds to the initial alignment direction.

In addition, precisely, the liquid crystal molecules LM are not exclusively aligned in parallel with a X-Y plane, but are pre-tilted in many cases. For this reason, the precise direction of the initial alignment is a direction in which an orthogonal projection of the alignment direction of the liquid crystal molecule LM at the time of OFF is carried out to the X-Y plane. However, in order to explain simply hereinafter, the liquid crystal molecule LM is assumed that the liquid crystal molecule LM is aligned in parallel with the X-Y plane, and is explained as what rotates in a field in parallel with the X-Y plane.

Here, both of the first alignment treatment direction PD1 of the first alignment film AL1 and the second alignment treatment direction PD2 of the second alignment film AL2 are directions in parallel to the second direction Y. At the time of OFF, the long axis of the liquid crystal molecule LM is aligned substantially in parallel to the second direction Y as shown with a dashed line in the figure. That is, the direction of the initial alignment of the liquid crystal molecule LM is in parallel to the second direction Y, or makes an angle of 0° with respect to the second direction Y.

When the respective directions of the alignment treatment of the first alignment film AL1 and the second alignment film AL2 are in parallel and the same directions each other, the liquid crystal molecule LM is aligned with approximately horizontal direction (i.e., the pre tilt angle is approximately zero) in a cross-section of the liquid crystal layer LQ in the intermediate portion of the liquid crystal layer LQ. The liquid crystal molecule LM is aligned with the pre-tilt angle so that the alignment of the liquid crystal molecule LM near the first alignment film AL1 and the second alignment film AL2 becomes symmetrical with respect to the intermediate portion of the liquid crystal layer LQ (splay alignment) In addition, when both of the first and second alignment treatment directions are in parallel, and are reverse directions each other, the liquid crystal molecule LM is aligned so that the liquid crystal molecule LM is aligned with an approximately uniform pre-tilt angle near the first and second alignment films AL1 and AL2 and in the intermediate portion of the liquid crystal layer LQ (homogeneous alignment).

A portion of the back light from the backlight 4 enters into the liquid crystal display panel LPN after penetrating the first polarizing plate PL1. The polarization state of the light which enters into the liquid crystal display panel LPN changes depending on the alignment state of the liquid crystal molecule LM when the light passes the liquid crystal layer LQ. At the time of OFF, the light which passes the liquid crystal layer LQ is absorbed by the second polarizing plate PL2 (black display).

On the other hand, in case where the potential difference is formed between the pixel electrode PE and the common electrode CE (at the time of ON), the lateral electric field in parallel to the substrate (or oblique electric field) is formed between the pixel electrode PE and the common electrode CE Thereby, the liquid crystal molecule LM rotates within a parallel plane with the substrate surface so that the long axis becomes in parallel with the direction of the electric field as shown in a solid line in FIG. 3.

In the illustrated example, the liquid crystal molecule LM in the region between the pixel electrode PE and the main common electrode CAL rotates clockwise with respect to the second direction Y, and aligns so that the liquid crystal molecule LM may turn to the lower left in the figure along with electric field. The liquid crystal molecule LM in the region between the pixel electrode PE and the main common electrode CAR rotates counterclockwise with reference to the second direction Y, and aligns so that the liquid crystal molecule LM may turn to the lower right in the figure along with electric field.

Thus, in each pixel PX, in case the lateral electric field (or oblique electric field) is formed between the pixel electrode PE and the common electrode CE, the alignment direction of the liquid crystal molecule LM is divided into a plurality of groups of directions, and domains are formed corresponding to respective alignment directions. That is, a plurality of domains is formed in each pixel PX.

At the time of ON, the light which entered into the liquid crystal panel LPN from the backlight 4 enters into the liquid crystal layer LQ. When the back light which entered into the liquid crystal layer LQ passes through the effective domain EFF, respectively, the polarization state changes. At the time of ON, at least a portion of light which passed the liquid crystal layer LQ penetrates the second polarizing plate PL2 (white display).

In this embodiment, the initial alignment direction of the liquid crystal molecule LM is substantially in parallel with the second direction Y, however, may be an oblique direction D crossing the second direction Y. Here, the angle θ1 between the first direction Y and the initial alignment direction D is set to an angle larger than 0° and smaller than 45°. From a viewpoint of alignment control of the liquid crystal molecules, it is extremely effective that the angle θ1 is set to approximately 5° to 30°, and more preferably, less than 20° (for example 7°). That is, it is desirable to set the direction of initial alignment of the liquid crystal molecule LM in parallel with the direction which makes angle in a range of 0° to 20° with respect to the second direction Y.

Moreover, although a case where the liquid crystal layer LQ is constituted by liquid crystal material with positive dielectric anisotropy is explained, the liquid crystal layer LQ with negative dielectric anisotropy may be used. However, although detailed explanation is omitted, since dielectric anisotropy is a reverse relation between the positive/negative, in case negative type liquid crystal material is used, it is desirable that the above-mentioned angle θ1 is set to a range of 45° to 90°, more desirably not less than 70°.

Furthermore, at the time of ON, since the lateral electric field is hardly formed (or sufficient electric field to drive the liquid crystal molecule LM is not formed) near the pixel electrode PE and the common electrode CE, the liquid crystal molecule LM hardly moves from the initial alignment direction like at the time of OFF. For this reason, as mentioned-above, even if the pixel electrode PE and the common electrode CE are formed of the electric conductive material with the light transmissive characteristics in these regions, back light hardly penetrates, i.e., hardly contributes to the display at the time of ON. Therefore, the pixel electrode PE and the common electrode CE do not necessarily need to be formed of a transparent electric conductive material, and may be formed using electric conductive materials, such as aluminum and silver.

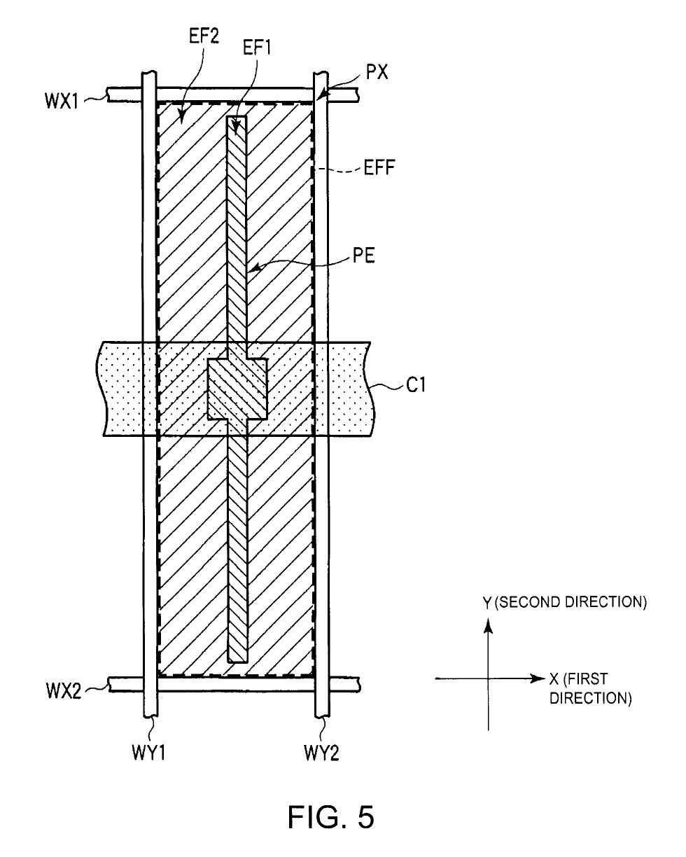

Next, the aperture in the effective domain EFF is explained in the liquid crystal display panel LPN of the above-mentioned structure. FIG. 5 is a plan view schematically showing the effective domain EFF formed in one pixel PX.

The effective domain EFF corresponds to a region surrounded by a horizontal line WX1 and a horizontal line WX2 which extend along the first direction X, and a vertical line WY1 and a vertical line WY2 which extend along the second direction Y. In the above-mentioned first embodiment, the horizontal line WX1 and the horizontal line WX2 which define the effective domain EFF correspond to the gate line G1 and the gate line G2, respectively. Moreover, the width of the main common electrode CA in the first direction X is equal to or larger than the width of the source line S in the first direction X like the first embodiment, and the vertical line WY1 and the vertical line WY2 which define the effective domain EFF correspond to the main common electrode CAL and the main common electrode CAR, respectively, in case the main common electrode CA runs off the position right above the source line S extending to the pixel electrode PE side. In addition, in case the width of the main common electrode CA in the first direction X is smaller than the width of the source line S in the first direction X, and the source line S runs off the position right under the main common electrode CA extending the pixel electrode PE side, the respective vertical line WY1 and the vertical line WY2 which define the effective domain EFF correspond to the source line S1 and the source line S2, respectively.

In the effective domain EFF, an electrode portion EF1 including the pixel electrode PE corresponds to a region which is shown in a slash line extending to a lower right direction in the figure. Moreover, in the effective domain EFF, an aperture portion EF2 other than the electrode portion EF1 is a region surrounded with the gate line G1, the gate line G2, the vertical line WY1 and the vertical line WY2, and is shown with a slash line extending to upper light direction in the figure.

In this embodiment, a first area of the electrode portion EF1 is smaller than a second area of the aperture portion EF2 in the effective domain EFF in a X-Y plane. An aperture which contributes to the display is formed in the regions which do not overlap with any of the lines and the electrodes in the effective domain EFF. That is, the gate line G, the source line S, and the auxiliary capacitance line C are formed of electric conductive materials which hardly penetrate light, such as molybdenum, aluminum, tungsten, and titanium. Moreover, though the pixel electrode PE and the common electrode CE are formed of the transmissive electric conductive material as above-mentioned, they hardly penetrate light at the time of ON. For this reason, the aperture is formed on the both sides which sandwich the auxiliary capacitance line C1 in the aperture portion EF2, i.e., the region which does not overlap with the auxiliary capacitance line C1, in the illustrated example.

In case, the black matrix BM extends from the position right above the source line S1 and the source line S2, and the position right above the gate line G1 and the gate line G2 to the pixel electrode PE side in the effective domain EFF, the extending region does not contribute to the display. Accordingly, the extending region is deducted from the second area of the aperture portion.

According to the first embodiment, the liquid crystal display panel LPN is constituted by attaching the array substrate AR provided with one pixel electrode PE in the center of one pixel PX, and the counter substrate CT provided with the main common electrodes CA at the both ends in one pixel PX, respectively. Especially, the aperture portion that contributes to the display in one pixel PX in this embodiment is formed in the gap between the pixel electrode PE and the common electrode CE. That is, the transmissivity in the pixel PX is decided by regions in which backlight penetrates the gap between the pixel electrode PE and the common electrode CE. In the effective domain EFF of the pixel PX, since the second area of the aperture portion EF2 is larger than the first area of the electrode region EF1, high transmissivity can be obtained.

Moreover, the main common electrode CA counters with the source lines S, respectively. When the main common electrode CAL and the main common electrode CAR are especially arranged right above the source line S1 and the source line S2, respectively, without running off the source lines S1 and S2, the aperture portion can be expanded and it becomes possible to improve the transmissivity of the pixel PX as compared with the case where the main common electrode CAL and the main common electrode CAR are arranged at the pixel electrode PE side (i.e., extending to the effective domain EFF) rather than right above the source line S1 and the source line S2.

Moreover, by arranging the main common electrode CAL and the main common electrode CAR right above the source line S1 and the source line S2, respectively, it becomes possible to expand the inter-electrode distance between the pixel electrode PE and the main common electrode CAL, and between the pixel electrode PE and the main common electrode CAR, and also to form more lateral electric field. For this reason, it also becomes possible to maintain a wide viewing angle characteristics which is one advantage of the general IPS mode.

Since it becomes possible to form two or more domains in one pixel, the viewing angle in two or more directions can be compensated optically, and a wide viewing angle is attained.

Therefore, the display with high transmissivity can be realized and it becomes possible to offer a high quality liquid crystal display device.

Moreover, according to the first embodiment, it becomes possible to correspond to the demand for various pixel pitches by changing the inter-electrode distance between the pixel electrode PE and the common electrode CE. That is, in a wide range from a low resolution specification with comparatively large electrode pitch to a large resolution specification with comparatively small electrode pitch, it becomes possible to offer the LCD panel with various pixel pitches by setting up suitably the inter-electrode distance without a microscopic electrode processing.

Furthermore, according to this embodiment, when an arrangement shift occurs between the array substrate AR and the counter substrate CT, a difference of the inter-electrode distance may arise between the pixel electrode PE and the common electrode CE on the both sides sandwiching the pixel electrode PE. However, since the shift is produced in common to all the pixels PX, there is no difference between the electric field distribution between the pixels PX, and the influence to the display of the image is very small. Moreover, even if the assembling shift arises between the array substrate AR and the counter substrate CT, it becomes possible to control the undesirable electric field leak to the adjoining pixels. For this reason, even if it is a case where the color of a color filter differs between the adjoining pixels, it becomes possible to control generating of mixed colors, and also becomes possible to realize more genuine color reproducibility nature.

The effect described here is explained in detail hereinafter.

Here, the FFS mode is briefly explained as a display mode for comparison.

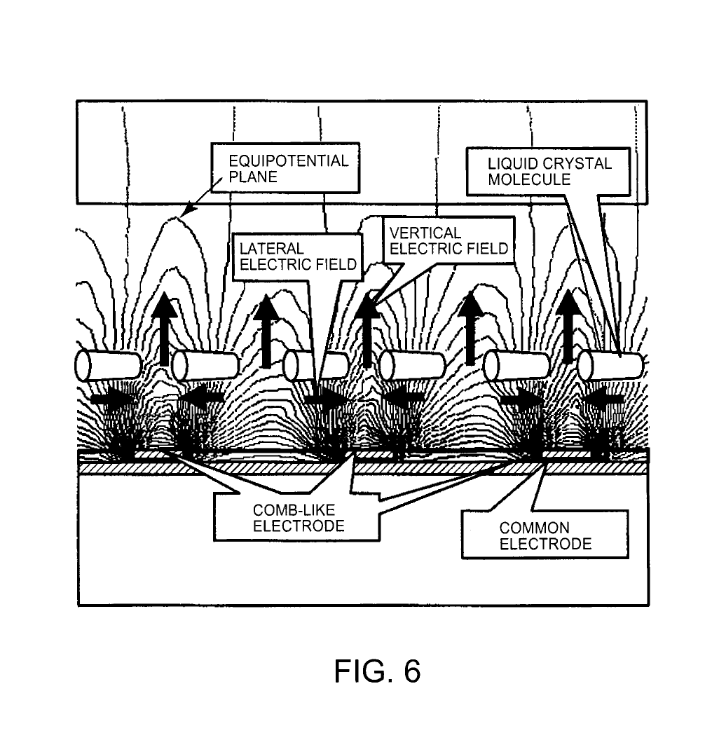

FIG. 6 is a figure showing the electric field distribution in one pixel in the liquid crystal display panel in the FFS mode.

The FFS mode is a display mode in which the liquid crystal molecule is operated in a horizontal direction to a substrate face by providing a common electrode and a comb-like electrode on the array substrate and using lateral electric field generated at the edge of the comb-like electrode. The FFS mode differs from the MVA (Multi-domain Vertical Alignment) system which operates the liquid crystal molecule in a normal direction of the substrate. The FFS mode has a feature that retardation change between a case where the display is looked from a front side and a case where the display is looked from an oblique direction is small, and that the gradation characteristic in the oblique direction is excellent. However, since vertical electric field is formed except edge portions of the comb-like electrode, as illustrated, there is the necessity of increasing the number of the edge portions of the comb-like electrode in order to make transmissivity high enough. A micro fabrication process to form the comb-like electrode by setting the electrode width to several μm or less is indispensable. Further, an expensive photolithography machine is required for processing the electrode.

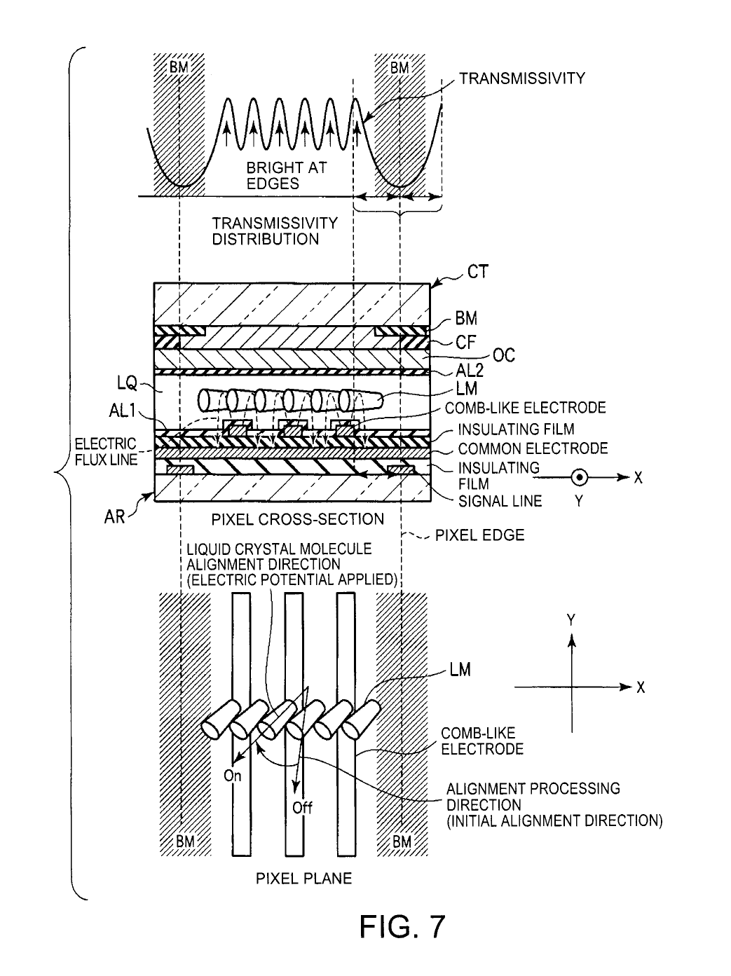

FIG. 7 is a figure showing the relation between the director of a liquid crystal molecule and transmissivity by electric field between the comb-like electrode and the common electrode in the FFS mode in the liquid crystal display panel shown in FIG. 6.

In the OFF state, the liquid crystal molecule LM is initially aligned in the direction slightly oblique to the second direction Y. In the state of ON in which potential difference is formed between the comb-like electrode and the common electrode, the director of the liquid crystal molecule LM becomes in parallel with a direction of 45° to 225°, within the X-Y plane, and peak transmissivity is obtained. If its attention is paid to transmissivity distribution of the pixel at this time, the transmissivity is high near edge portions of the comb-like electrode, and transmissivity is low on a comb-like electrode or between the adjacent comb-like electrodes. In the illustrated example, the number of comb-like electrodes is three, and six transmissivity peaks appear. Therefore, in order to make transmissivity of the pixel high enough, it is necessary, as above-mentioned, to increase the number of comb-like electrodes and to increase the number of edge portions.

Moreover, if its attention is paid to transmissivity distribution in a region which overlaps with the black matrix BM, the transmissivity does not fully fall. This is because undesirable lateral electric field is produced between the adjoining pixels, and the liquid crystal molecule between the adjoining pixels is also operated. In such a case, when the colors of the color filter differ between the adjoining pixels, mixed colors occur and there is a possibility of causing the fall of color reproducibility and a contrast ratio. In particular, when the assembling shift between the array substrate and the counter substrate occurs, the region between the adjoining pixels is exposed from the black matrix BM, and also the optical leak becomes remarkable. Therefore, it is necessary to form greatly the distance between the adjoining pixels or the width of the black matrix BM, which results in one of the factors that bar to achieve high resolution in the FFS mode. In addition, the optical leak by the assembling shift between the array substrate and the counter substrate is originated not only in the FFS mode but other display modes which mainly use a vertical electric field, such as the MVA mode.

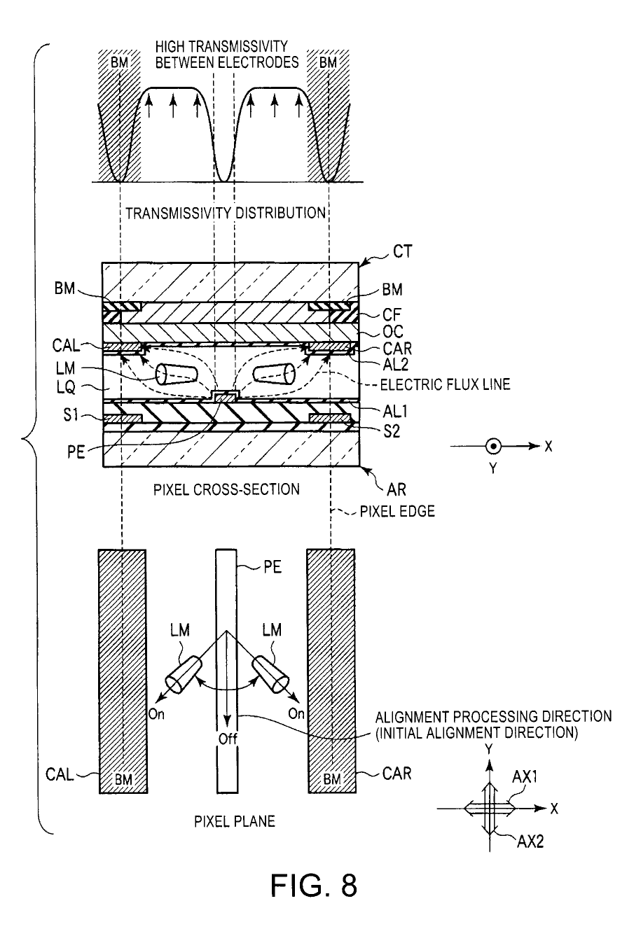

FIG. 8 is a figure showing the relation between the director of the liquid crystal molecule and transmissivity by electric field between the pixel electrode and the common electrode in the liquid crystal display panel according to the first embodiment.

In the OFF state, the liquid crystal molecule LM is aligned in a direction in parallel to the second direction Y. In the ON state in which potential difference is formed between the pixel electrode PE and the common electrode CE, in case the director (or the direction of the long axis) of the liquid crystal molecule LM shifts by approximately 45° with respect to the first polarization axis (or absorption axis) AX1 of the first polarizing plate PL1 and the second polarization axis (or absorption axis) AX2 of the second polarizing plate PL2, an optical modulation rate of the liquid crystal molecules becomes the highest. In the illustrated example, in the ON state, the director of the liquid crystal molecule LM becomes a direction substantially in parallel to a direction of 45° to 225°, or a direction of 135° to 315° within the X-Y plane, and peak transmissivity is obtained.

If its attention is paid to the transmissivity distribution of one pixel at this time, while the transmissivity becomes zero on the pixel electrode PE and the common electrode CE, high transmissivity is obtained in the whole electrode gap between the pixel electrode PE and the common electrode CE. More specifically, the main common electrode CAL located right above the source line S1 and the main common electrode CAR located right above the source line S2 counter with the black matrix BM, respectively. The main common electrodes CAL and the main common electrode CAR have the widths in the first direction X equal to or smaller than the black matrix BM, and do not extend to the pixel electrode PE side beyond a region which overlaps with the black matrix BM. For this reason, the regions which contribute to the display are regions between the pixel electrode PE and the main common electrodes CAL, and between the pixel electrode PE and the main common electrodes CAR in one pixel.

In this embodiment, the transmissivity of one pixel can be made sufficiently high by expanding the inter-electrode distance between the pixel electrode PE and the main common electrodes CAL and CAR. Moreover, it becomes possible to use the peak conditions of the transmissivity distribution as shown in FIG. 8 corresponding to the panel specifications in which the pixel pitch differs each other by changing the inter-electrode distance i.e., by changing the arrangement location of the main common electrode CA with respect to the pixel electrode PE arranged in the approximately center of the pixel PX.

In the FFS mode, it is necessary to increase the numbers of electrodes or the edge portions of the electrodes in order to obtain high transmissivity, and a fine processing is required. On the contrary, in this embodiment, high transmissivity can be obtained by expanding the inter-electrode distance, and the fine processing is not necessarily. Further, since a pixel pitch becomes small with the demanded for higher resolution in the FFS mode, still more the fine processing is required. Moreover, the number of the electrodes or the electrode size is restricted. On the contrary, in the display mode according to this embodiment, it becomes possible to realize the demand for high transmissivity and high resolution without receiving most of these restrictions.

Moreover, if its attention is paid to the transmissivity distribution in the region which overlaps with the black matrix BM, the transmissivity fully falls. This is because the leak of electric field does not occur on the outside of the pixel from the common electrode CE, and undesired lateral electric field is not produced between the adjoining pixels on both sides of the black matrix BM. That is, it is because the liquid crystal molecule of the region which overlaps with the black matrix BM maintains the state of initial alignment like the OFF time (or the time of a black display). Therefore, even if it is a case where the colors of the color filter differ between the adjoining pixels, it becomes possible to control the generating of mixed colors, and also becomes possible to control the fall of color reproducibility and the contrast ratio.

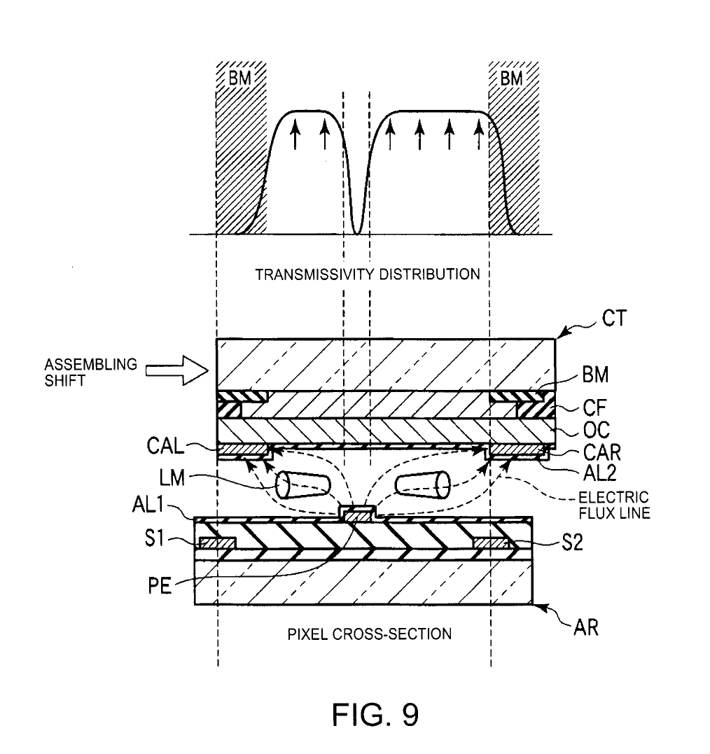

FIG. 9 is a figure showing the relation between the director of the liquid crystal molecule and transmissivity by electric field between the pixel electrode and the common electrode when an assembling shift arises between the array substrate and the counter substrate in the liquid crystal display panel according to the first embodiment.

In the illustrated example, while the inter-electrode distance between the pixel electrode PE and the main common electrode CAL becomes smaller, the inter-electrode distance between the pixel electrode PE and the main common electrode CAR is expanded due to the assembling shift. In this case, the director of the liquid crystal molecule LM in an ON state becomes the same direction as the example shown in FIG. 8. The total transmissivity of one pixel PX is substantially the same as the example shown in FIG. 8 though a shift of the peak point of the transmissivity distribution is produced at this time. Furthermore, the leak of electric field to the adjoining pixels is not produced, either.

Thus, in this embodiment, even if the assembling shift between the array substrate AR and the counter substrate CT arises, high transmissivity is obtained, and it becomes possible to control the optical leak. Moreover, in the display mode according to this embodiment, it is not necessary to expand the distance between the adjoining pixels, or the width of the black matrix BM as a measure against the optical leak, and it becomes possible to realize high resolution display easily as compared with the FFS mode or the MVA mode.

Next, the relation between the resolution and the transmissivity is explained comparing this embodiment with the FFS mode.

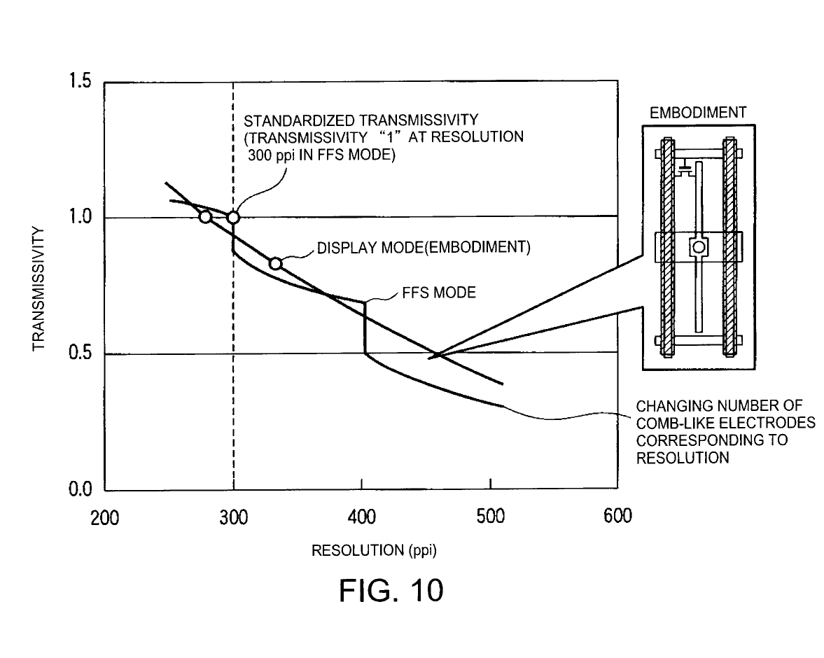

FIG. 10 is a figure showing a result of a simulation about the relation between the resolution and the transmissivity in the display mode according to the first embodiment and the FFS mode.

The calculation conditions herein are as follows. Regarding the display mode according to this embodiment, the width of the common electrode is 5 μm and the width of the pixel electrode PE is 3 μm. Regarding the FFS mode which is a comparative example, a common electrode is an electrode which is formed all over the pixel, and the width of the comb-like electrode is 3 μm. Each in the display mode according to this embodiment and the FFS mode, fixed white display voltages are impressed to the liquid crystal layers in all the examples.

In the FFS mode, as illustrated, the transmissivity falls step-like with increase of the resolution. This is because the number of the comb-like electrodes arranged in one pixel changes step-like, and the transmissivity falls greatly in the resolution in which the number of the electrodes changes. For example, although three comb-like electrodes per pixel are arranged in the resolution up to 300 ppi (pixel/inch), two comb-like electrodes per pixel are arranged in the resolution from 300 ppi to 400 ppi, and one comb-like electrode per one pixel is further arranged in the resolution of 400 ppi or more. For this reason, the transmissivity falls sharply in the cases where the resolutions are 300 ppi and 400 ppi, respectively.

Thus, when making a high definition display panel in the FFS mode, an unfavorable characteristics appears notably depending on the resolution. This is because optimal values exist in the inter-electrode distance and the width of the comb-like electrode. If the size of the electrode is first determined, the number of the comb-like electrodes is determined so that the pixel pitch is set by an integral multiple of the sum of the inter-electrode distance and the electrode width. On the contrary, the number of the electrode is first determined, the inter-electrode distance and the electrode width of the comb-like electrode are shifted from the optimal values. This influence becomes more serious as the pixel is designed for higher definition displays.

On the other hand, in the display mode according to this embodiment as illustrated, the transmissivity falls continuously with increase of the resolution. This is because only one pixel electrodes PE in one pixel is arranged irrespective of the resolution, and is because the transmissivity is determined only by changing the inter-electrode distance between the pixel electrode PE and the common electrode CE.

When a simulation of the transmissivity was carried out about the resolution 280 ppi according to this embodiment by standardizing the transmissivity of resolution 300 ppi to 1 in the FFS mode, the standardized value became about 1.04 times, and also became 0.8 times in case of resolution 340 ppi. The above result was confirmed that it was in agreement with the expected value that the transmissivity changes continuously with respect to the pixel pitch. Since the area of the aperture deceases with increase of the resolution, even if the electrode in the aperture is formed with one electrode line, the graph becomes on the down side. However, in the structure of one electrode line, the characteristic change does not become step-like as the FFS mode.

### Second Embodiment

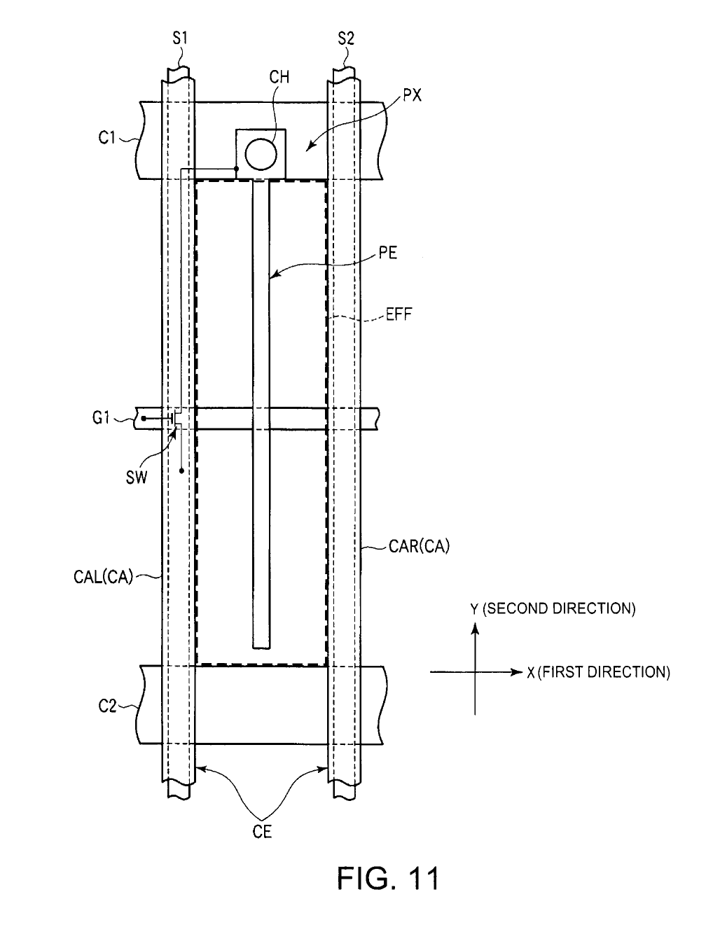

FIG. 11 is a plan view schematically showing the structure of one pixel when the liquid crystal display panel according to a second embodiment is seen from the counter substrate side.

The second embodiment differs from the first embodiment shown in FIG. 3 in the following point. In the pixel, the auxiliary capacitance line C1 is arranged at the upper side end, and precisely, the auxiliary capacitance line C1 is arranged striding over a boundary between the illustrated pixel and a pixel which adjoins the illustrated pixel PX in the upper portion. The auxiliary capacitance line C2 is arranged at the lower side end, and precisely, the auxiliary capacitance line C1 is arranged striding over a boundary between the illustrated pixel and a pixel which adjoins the illustrated pixel PX in the lower portion. The gate line G1 is arranged approximately in the central portion of the pixel. In addition, detailed explanation about the same structure as the first embodiment is omitted by attaching the same symbol.

The array substrate includes an auxiliary capacitance line C1 and an auxiliary capacitance line C2 extending along the first direction X, a gate line G arranged between the adjoining auxiliary capacitance line C1 and the auxiliary capacitance line C2 extending along the first direction X, the pixel electrode PE, and the source line S1 and the source line S2 extending along the second direction Y. In addition, following pints are the same as those in the first embodiment. The source line S1 is arranged at the left-hand side end in the pixel PX, the source line S2 is arranged at the right-hand side end, and the switching element SW is electrically connected with the gate line G1 and the source line S1 and is formed at an overlapped region with the source line S1 and the auxiliary capacitance line C1.

In the illustrated pixel PX, the effective domain EFF shown with a dashed line is a region surrounded with the auxiliary capacitance line C1 and the auxiliary capacitance line C2, the source line S1 and the source line S2, or the main common electrode CA, and is defined by an inside edge of each signal line, or an inside edge of the main common electrode CA. The effective domain EFF has a shape of a rectangle whose length in the second direction Y is longer than the length in the first direction X. That is, each edge of the auxiliary capacitance line C1 and the auxiliary capacitance line C2 which face each other corresponds to the short end of the effective domain EFF. Moreover, in the illustrated example, while each edge of the main common electrode CA which faces corresponds to the long end of the effective domain EFF, each edge of the source line S1 and the source line S2 which face each other may correspond to the long end of the effective domain EFF.

The pixel electrode PE is formed substantially like the first embodiment. In addition, in the illustrated example, the pixel electrode PE overlaps with the auxiliary capacitance line C1 at the upper side end of the pixel PX. In the region which overlaps with the auxiliary capacitance line C1, the pixel electrode PE is formed more broadly than other portions to secure contact for the switching element SW through a contact hole CH. Moreover, in the pixel electrode PE, the region which does not overlap with the auxiliary capacitance line C1 is formed so that it may have the substantially equal width along the first direction X.

The common electrode CE equipped on the counter substrate is formed like the first embodiment.

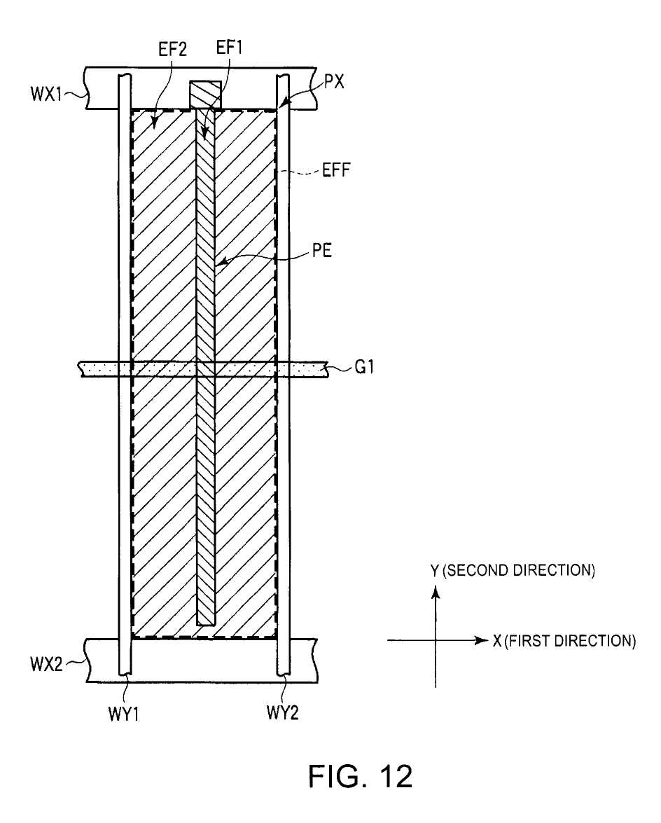

FIG. 12 is a plan view schematically showing the effective domain EFF formed in one pixel.

The effective domain EFF corresponds to the region surrounded by a horizontal line WX1 and the horizontal line WX2 extending along the first direction X, and the vertical line WY1 and the vertical line WY2 extending along the second direction Y. In the above-mentioned second embodiment, the horizontal line WX1 and the horizontal line WX2 correspond to the auxiliary capacitance line C1 and the auxiliary capacitance line C2, respectively. Moreover, the width of the main common electrode CA in the first direction X is equal to or larger than the width of the source line S in the first direction X. In case the main common electrode CA extends to the pixel electrode PE side rather than the position right above the source line S, the vertical line WY1 and the vertical line WY2 which define the effective domain EFF correspond to the main common electrode CAL and the main common electrode CAR, respectively. In addition, when the width of the main common electrode CA in the first direction X is smaller than the width of the source line S in the first direction X, and source line S extends from the position right under the main common electrode CA to the pixel electrode PE side, the vertical line WY1 and the vertical line WY2 which define the effective domain EFF correspond to the source line S1 and the source line S2, respectively.

In the effective domain EFF, the electrode portion EF1 including the pixel electrode PE corresponds to a region shown in a diagonally right down slash line in the figure. Moreover, in the effective domain EFF, the aperture portion EF2 other than the electrode portion EF1 is located between the auxiliary capacitance line C1 and the auxiliary capacitance line C2, and between the pixel electrode PE and the vertical lines WY1 and WY2, and corresponds to a region shown with a diagonally upward slash line in the figure. Also in the second embodiment shown here, the first area of the electrode portion EF1 is smaller than the second area of the aperture portion EF2 in the effective domain EFF in the X-Y plane.

The aperture in the effective domain EFF is formed on the both sides which sandwich the gate line G1 in the aperture portion EF2, i.e., the region which does not overlap with the gate line G1 in the liquid crystal display panel LPN.

Also in the second embodiment, since the liquid crystal alignment are controlled by the pixel electrode PE arranged substantially in the center of the pixel PX and the common electrode CE arranged at the right-and-left pixel ends like the above-mentioned first embodiment, the same effect as the first embodiment is acquired.

### Third Embodiment

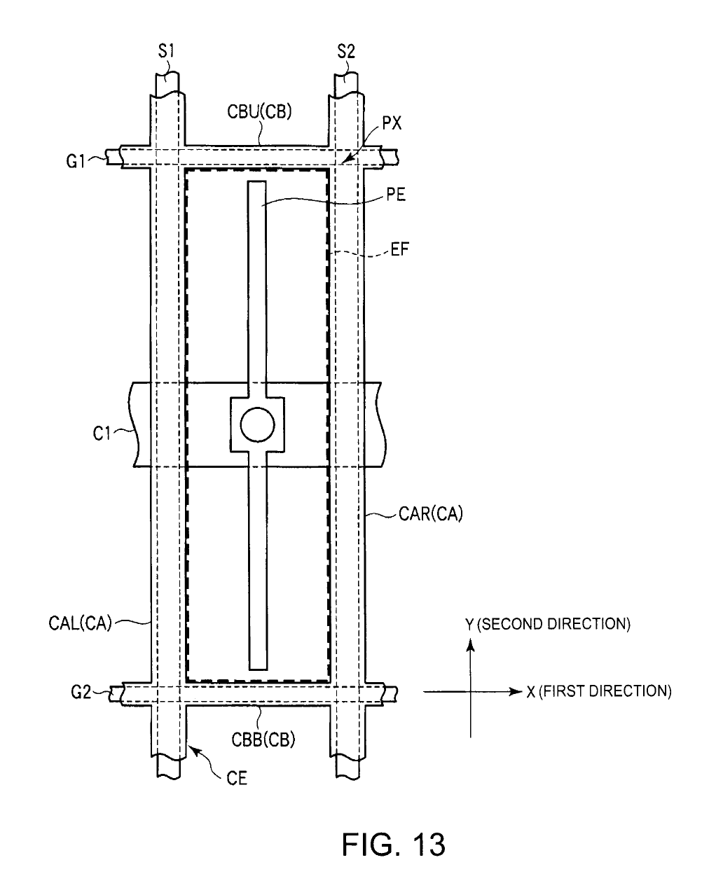

FIG. 13 is a plan view schematically showing the structure of one pixel when the liquid crystal display panel according to a third embodiment is seen from the counter substrate side.

The third embodiment is different from the first embodiment shown in FIG. 3 in the point that the common electrode CE equipped on the counter substrate CT is formed in the shape of a lattice so that the common electrode CE surrounds the pixel as compared with the example of the first embodiment.

In addition, detailed explanation about the same structure as the first embodiment is omitted by attaching the same symbol.

The common electrode CE includes a sub-common electrode CB which extends along the first direction X besides the above-mentioned main common electrode CA. The main common electrode CA and the sub-common electrode CB are integrally or continuously formed to make the lattice shape.

The sub-common electrode CB counters with each of the gate lines G. In the illustrated example, the sub-common electrode CB is constituted by two lines extending along the first direction X. In order to distinguish the two lines, the sub-common electrode of the upper portion in the figure is called CBU, and the sub-common electrode of the bottom portion in the figure is called CBB hereinafter. The sub-common electrode CBU is arranged at the upper portion end of the pixel PX, and counters with the gate line G1. That is, the sub-common electrode CBU is arranged striding over a boundary between the illustrated pixel and a pixel adjoining the illustrated pixel PX on its upper side. Moreover, the sub-common electrode CBB is arranged at the bottom end of the pixel PX, and counters with the gate line G2. That is, the sub-common electrode CBB is arranged striding over a boundary between the illustrated pixel and a pixel adjoining the illustrated pixel PX on the bottom side.

Moreover, the sub-common electrode CB has a width equal to or larger than the width of the gate line G which counters the sub-common electrode CB. In the illustrated example, the width of the sub-common electrode CBU in the second direction Y is larger than the width of the gate line G1 which counters the sub-common electrode CBU, and has the width equal to or smaller than the black matrix BM. Moreover, the sub-common electrode CBU is arranged right above the gate line G1, and is arranged right under the black matrix BM. Therefore, the sub-common electrode CBU does not extend from the position right under the black matrix BM to the effective domain EFF side. That is, the sub-common electrode CBU does not extend to the pixel electrode side from the position right under the black matrix BM. The width of the sub-common electrode CBB in the second direction Y is larger than the width of the gate line G2 which counters the sub-common electrode CBB, and has the width equal to or smaller than the black matrix BM. Moreover, the sub-common electrode CBB is arranged right above the gate line G2, and is arranged right under the black matrix BM. Therefore, the sub-common electrode CBB does not extend from the position right under the black matrix BM to the effective domain EFF side. That is, the sub-common electrode CBU does not extend to the pixel electrode side from the position right under the black matrix BM. Thus, when the sub-common electrode CB is arranged in pixel PX, reduction of the area of the aperture which contributes to a display is controlled.

In case the sub-common electrode CB has a width larger than that of the gate line G which counters the sub-common electrode CB, the sub-common electrode CB extends from the position right above the gate line G to the pixel electrode PE side. Inside edges of the sub-common electrodes CB which face each other correspond to the short ends of the effective domain EFF. However, in order to control reduction of the area of the aperture as much as possible, it is desirable to set up the area of the sub-common electrode CB extending to the pixel electrode PE side as small as possible.

In addition, the sub-common electrode CB may have a width smaller than the width of the gate line G which counters the sub-common electrode CB. In this case, the gate line G extends from the position right under the sub-common electrode CB to the pixel electrode PE side, and the inside edges of the gate lines which face each other correspond to the short ends of the effective domain EFF.

In the third embodiment, the aperture portion of the effective domain EFF formed in the pixel PX is explained referring to FIG. 5.

The effective domain EFF corresponds to a region surrounded by the horizontal line WX1 and the horizontal line WX2 which extend along the first direction X, and the vertical line WY1 and the vertical line WY2 which extend along the second direction Y. Also in this third embodiment, each of the vertical line WY1 and the vertical line WY2 which define the effective domain EFF is the main common electrode CAL and the main common electrode CAR or the source line S1 and the source line S2.

Moreover, when the width of the sub-common electrode CB in the second direction Y is equal to or larger than the width of the gate line G in the second direction Y, and the sub-common electrode CB extends from the position right above the gate line G to the pixel electrode PE side, the horizontal line WX1 and the horizontal line WX2 which define the effective domain EFF correspond to the sub-common electrode CBU and the sub-common electrode CBB, respectively. In addition, when the width in the second direction Y of the sub-common electrode CB is smaller than the width of the gate line G in the second direction Y, and the gate line G extends from the position right under the sub-common electrode CB to the pixel electrode PE side, the horizontal line WX1 and the horizontal line WX2 which define the effective domain EFF correspond to the gate line G1 and the gate line G2, respectively.

Also in the third embodiment shown here, the first area of the electrode portion EF1 is smaller than the second area of the aperture portion EF2 in the effective domain EFF in the X-Y plane.

In the third embodiment, since the view of controlling the liquid crystal alignment by the pixel electrode PE arranged substantially in the center of the pixel PX and the common electrode CE arranged at the pixel end is the same as that of the above-mentioned first embodiment, the same effect as the first embodiment is acquired.

### Fourth Embodiment

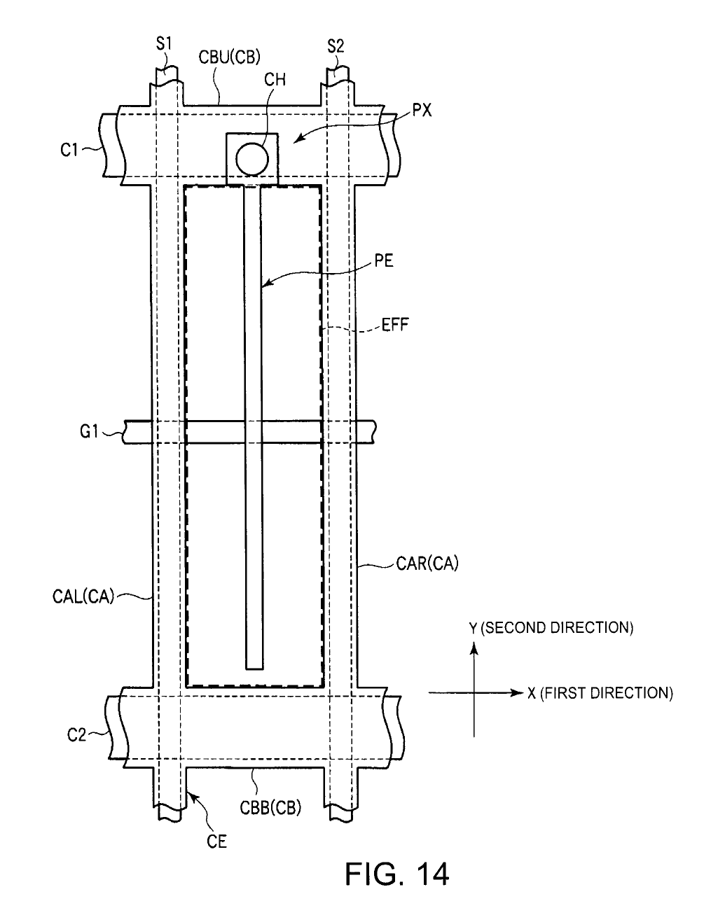

FIG. 14 is a plan view schematically showing the structure of one pixel when the liquid crystal display panel according to a fourth embodiment is seen from the counter substrate side.

The fourth embodiment is different from the second embodiment shown in FIG. 11 in the point that the common electrode CE equipped on the counter substrate CT is formed so that the common electrode CE surrounds the pixel. In addition, detailed explanation about the same structure as the second embodiment is omitted by attaching the same symbol.

The common electrode CE includes the sub-common electrode CB which extends along the first direction X besides the above-mentioned main common electrode CA like the third embodiment. The main common electrodes CA and the sub-common electrode CB are integrally or continuously formed to make a lattice shape.

The sub-common electrode CB counters with each of the auxiliary capacitance line C. The sub-common electrode CBU arranged at the upper end of the pixel PX counters with the auxiliary capacitance line C1. Moreover, the sub-common electrode CBB arranged at the bottom end of the pixel PX counters with the auxiliary capacitance line C2.

Moreover, the sub-common electrode CB has a width equal to or larger than the width of the auxiliary capacitance line C which counters the sub-common electrode CB. In the illustrated example, the width of the sub-common electrode CBU in the second direction Y is larger than the width of the auxiliary capacitance line C1 which counters the sub-common electrode CBU, and has the width equal to or smaller than the black matrix BM. Moreover, the sub-common electrode CBU is arranged right above the auxiliary capacitance line C1, and is arranged right under the black matrix BM. Therefore, the sub-common electrode CBU does not extend from the position right under the black matrix BM to the effective domain EFF side. That is, the sub-common electrode CBU does not extend from the position right under the black matrix BM to the pixel electrode PE side. The width of the sub-common electrode CBB in the second direction Y is larger than the width of the auxiliary capacitance line C2 which counters the sub-common electrode CBB, and has the width equal to or smaller than the black matrix BM. Moreover, the sub-common electrode CBB is arranged right above the auxiliary capacitance line C2, and is arranged right under the black matrix BM. Therefore, the sub-common electrode CBB does not extend from the position right under the black matrix BM to the effective domain EFF side. That is, the sub-common electrode CBB does not extend from the position right under the black matrix BM to the pixel electrode PE side. Thus, when the sub-common electrode CB is arranged in the pixel PX, reduction of the area of the aperture which contributes to a display is controlled.

Thus, in case the sub-common electrode CB has a width larger than that of the auxiliary capacitance line C which counters the sub-common electrode CB, the sub-common electrode CB extends from the position right above the auxiliary capacitance line C to the pixel electrode PE side. Inside edges of the sub-common electrodes CB which face each other correspond to the short ends of the effective domain EFF. However, in order to control reduction of the area of the aperture as much as possible, it is desirable to set up the area of the sub-common electrode CB extending to the pixel electrode PE side as small as possible.

In addition, the sub-common electrode CB may have a width smaller than the width of the auxiliary capacitance line C which counters the sub-common electrode CB. In this case, the auxiliary capacitance line C extends from the position right under the sub-common electrode CB to the pixel electrode PE side, and the inside edges of the auxiliary capacitance line C which faces each other correspond to the short ends of the effective domain EFF.

In this fourth embodiment, the aperture portion of the effective domain EFF formed in one pixel PX is explained referring to FIG. 12.

The effective domain EFF corresponds to a region surrounded by the horizontal line WX1 and the horizontal line WX2 which extend along the first direction X, and the vertical line WY1 and a vertical line WY2 which extend along the second direction Y. Also in this fourth embodiment, each of the vertical line WY1 and the vertical line WY2 which define the effective domain EFF is the main common electrode CAL and the main common electrode CAR or the source line S1 and the source line S2.

Moreover, when the width of the sub-common electrode CB in the second direction Y is equal to or larger than the auxiliary capacitance line C in the second direction Y, and the sub-common electrode CB extends from the position right above the auxiliary capacitance line C to the pixel electrode PE side, the horizontal line WX1 and the horizontal line WX2 which define the effective domain EFF correspond to the sub-common electrode CBU and the sub-common electrode CBB, respectively. In addition, when the width in the second direction Y of the sub-common electrode CB is smaller than the width of the auxiliary capacitance line C in the second direction Y, and the auxiliary capacitance line C extends from the position right under the sub-common electrode CB to the pixel electrode PE side, the horizontal line WX1 and the horizontal line WX2 which define the effective domain EFF correspond to the auxiliary capacitance line C1 and the auxiliary capacitance line C2, respectively.

Also in the fourth embodiment shown here, the first area of the electrode portion EF1 is smaller than the second area of the aperture portion EF2 in the effective domain EFF in the X-Y plane.

In the fourth embodiment, since the view of controlling the liquid crystal alignment by the pixel electrode PE arranged substantially in the center of the pixel PX and the common electrode CE arranged at the pixel end is the same as that of the above-mentioned first embodiment, the same effect as the first embodiment is acquired.

As explained above, according to the embodiment, it becomes possible to offer the high quality liquid crystal display device.

While certain embodiments have been described, these embodiments have been presented by way of embodiment only, and are not intended to limit the scope of the inventions. In practice, the structural elements can be modified without departing from the spirit of the invention. Various embodiments can be made by properly combining the structural elements disclosed in the embodiments. For embodiment, some structural elements may be omitted from all the structural elements disclosed in the embodiments. Furthermore, the structural elements in different embodiments may properly be combined. The accompanying claims and their equivalents are intended to cover such forms or modifications as would fall with the scope and spirit of the inventions.

What is claimed is:

1. A liquid crystal display device, comprising:
a first substrate including;
a pair of first signal lines extending in a first direction and a pair of second signal lines extending in a second direction orthogonally crossing the first direction, and
a pixel electrode arranged between the pair of second signal lines and extending in the second direction,
a second substrate including a common electrode having a first main common electrode and a second main common electrode respectively facing the pair of second signal lines and extending in the second direction, and
a liquid crystal layer having liquid crystal molecules and held between the first substrate and the second substrate;
wherein the liquid crystal display device further includes an effective domain surrounded by the pair of first signal lines and the pair of second signal lines, or by the pair of first signal lines and the first and the second main common electrodes, and a first area formed of an electrode portion including the pixel electrode is smaller than a second area formed of an aperture portion other than the first area in the effective domain.

2. The liquid crystal display device according to claim 1, wherein the pair of first signal lines are formed of gate lines and the pair of the second signal lines are formed of source lines.

3. The liquid crystal display device according to claim 1, wherein the first substrate further includes an auxiliary capacitance line arranged between the pair of first signal lines extending in the first direction, and an aperture for contributing to display images is formed on both sides sandwiching the auxiliary capacitance line.

4. The liquid crystal display device according to claim 1, wherein the pair of first signal lines are formed of auxiliary capacitance lines and the pair of the second signal lines are formed of source lines.

5. The liquid crystal display device according to claim 1, wherein the first substrate further includes a gate line arranged between the pair of first signal lines extending in the first direction, and an aperture for contributing to display images is formed on both sides sandwiching the gate line.

6. The liquid crystal display device according to claim 1, wherein the first and second main common electrodes have widths equal to or larger than those of the pair of second signal lines.

7. The liquid crystal display device according to claim 6, wherein the first and second main common electrodes do not extend from a position right under a black matrix formed on the second substrate to the pixel electrode side.

8. The liquid crystal display device according to claim 1, wherein an initial alignment direction of the liquid crystal molecules is a direction in parallel with a direction making an angle with respect to the second direction in a range of 0° to 20° in a state where electric field is not formed between the pixel electrode and the common electrode.

9. The liquid crystal display device according to claim 8, wherein the liquid crystal molecules are aligned in a splay alignment state or a homogeneous alignment state between the first substrate and the second substrate in a state where electric field is not formed between the pixel electrode and the common electrode

10. The liquid crystal display device according to claim 1, further comprising a first polarizing plate formed on an outer surface of the first substrate and a second polarizing plate formed on an outer surface of the second substrate, wherein a first polarization axis of the first polarizing plate crosses orthogonally a second polarization axis of the second polarizing plate, and the first polarization axis of the first polarizing plate crosses or in parallel with an initial alignment direction of the liquid crystal molecules.

11. A liquid crystal display device, comprising:
a first substrate including;
a pair of first signal lines extending in a first direction and a pair of second signal lines extending in a second direction orthogonally crossing the first direction, and
a pixel electrode arranged between the pair of second signal lines and extending in the second direction,
a second substrate including a common electrode having a pair of main common electrodes respectively facing the pair of the second signal lines and extending in the second direction and a pair of sub-common electrodes respectively facing the pair of the first signal lines and extending in the first direction, the pair of main common electrodes and the pair of the sub-common electrodes forming a lattice shape; and
a liquid crystal layer having liquid crystal molecules and held between the first substrate and the second substrate;
wherein the liquid crystal display device further includes an effective domain surrounded by the pair of first signal lines and the pair of second signal lines, or by the pair first signal lines and the pair of main common electrodes, and a first area formed of an electrode portion including the pixel electrode is smaller than a second area formed of an aperture portion other than the first area in the effective domain.

12. The liquid crystal display device according to claim 11, wherein the first and second sub-common electrodes have widths equal to or larger than those of the pair of first signal lines.

13. The liquid crystal display device according to claim 12, wherein the first and second sub-common electrodes do not extend from a position right under a black matrix formed on the second substrate to the pixel electrode side.

14. The liquid crystal display device according to claim 11, wherein an initial alignment direction of the liquid crystal molecules is a direction in parallel with a direction making an angle with respect to the second direction in a range of 0° to 20° in a state where electric field is not formed between the pixel electrode and the common electrode.

15. The liquid crystal display device according to claim 14, wherein the liquid crystal molecules are aligned in a splay alignment state or a homogeneous alignment state between the first substrate and the second substrate in a state where electric field is not formed between the pixel electrode and the common electrode.

16. The liquid crystal display device according to claim 11, further comprising a first polarizing plate formed on an outer surface of the first substrate and a second polarizing plate formed on an outer surface of the second substrate, wherein a first polarization axis of the first polarizing plate crosses orthogonally a second polarization axis of the second polarizing plate, and the first polarization axis of the first polarizing plate crosses or in parallel with an initial alignment direction of the liquid crystal molecules.

17. A liquid crystal display device, comprising:
a first substrate including;
a pair of first signal lines extending in a first direction and a pair of second signal lines extending in a second direction orthogonally crossing the first direction, and
a pixel electrode arranged between the pair of second signal lines and extending in the second direction,
a second substrate including a common electrode having a pair of main common electrodes respectively facing the pair of the second signal lines and extending in the second direction and a pair of sub-common electrodes respectively facing the pair of the first signal lines and extending in the first direction, the pair of main common electrodes and the pair of the sub-common electrodes forming a lattice shape; and
a liquid crystal layer having liquid crystal molecules and held between the first substrate and the second substrate;
wherein the liquid crystal display device further includes an effective domain surrounded by the pair of sub-common electrodes and the pair of second signal lines, or by the pair sub-common electrodes and the pair of main common electrodes, and a first area formed of an electrode portion including the pixel electrode is smaller than a second area formed of an aperture portion other than the first area in the effective domain.

18. The liquid crystal display device according to claim 17, wherein the first and second sub-common electrodes have widths equal to or larger than those of the pair of first signal lines.

19. The liquid crystal display device according to claim 18, wherein the first and second sub-common electrodes do not extend from a position right under a black matrix formed on the second substrate to the pixel electrode side.
